(19) United States
(12) Patent Application Publication
(10) Pub. No.: US 2010/0267553 A1
(43) Pub. Date: Oct. 21, 2010

(54) Tungsten-containing Mesoporous Silica Thin Film, Highly Hydrophilic Material Containing the Same, and Method for Producing Tungsten-Containing Mesoporous Silica Thin Film

(75) Inventors: Tadahiro Kaminade, Kanagawa (JP); Hiromi Yamashita, Osaka (JP); Kohsuke Mori, Osaka (JP); Shinichi Kawasaki, Osaka (JP); Yu Horiuchi, Osaka (JP); Yuki Miura, Osaka (JP); Norikazu Nishiyama, Osaka (JP)

Correspondence Address: FITCH, EVEN, TABIN & FLANNERY, P. O. BOX 18415, WASHINGTON, DC, 20036, US

(73) Assignee: NIPPON OIL CORPORATION, TOKYO (JP)

(21) Appl. No.: 12/678,102

(22) PCT Filed: Aug. 28, 2008
(86) PCT No.: PCT/JP2008/065405

§ 371 Date: Apr. 19, 2010

(30) Foreign Application Priority Data
Sep. 14, 2007 (JP) 2007-238750

(51) Int. Cl. B01J 21/08

(52) U.S. Cl. 502/254

(57) ABSTRACT

A tungsten-containing mesoporous silica thin film, which is a mesoporous silica thin film formed from a solution containing a silica precursor and a water-soluble tungsten compound, and has a molar ratio (W/Si) of tungsten content to silicon content of 0.001 to 0.04, a film thickness of 0.1 to 5 μm, and an average pore diameter of 20 nm or less.

### TECHNICAL FIELD

The present invention relates to a highly hydrophilic silica thin film, a highly hydrophilic material containing the same, and a method for producing the silica thin film.

### BACKGROUND OF THE INVENTION

Composite materials comprising a hydrophilic film formed on a substrate surface have excellent properties such as antifouling property, antifogging property, quick-drying property, antistatic property, and dew condensation prevention property. Therefore, many commercial products comprising a hydrophilic film have been developed and marketed. Recently, high-performance hydrophilic composite materials in each of which a film containing titanium oxide having photocatalytic property is formed on a surface thereof have been proposed.

For example, Japanese Unexamined Patent Application Publication No. Hei 10-330131 (Document 1) discloses a glass product comprising a glass substrate, a photocatalyst layer being formed on a surface of the glass substrate and containing titanium dioxide and the like, and a top layer formed on a surface of the photocatalyst layer and made from a thin film of a metal compound such as silicon dioxide. Japanese Unexamined Patent Application Publication No. 2000-1340 (Document 2) discloses a hydrophilic film of a bilayer structure having a film of a metal oxide as a first layer, and another film formed from fine particles of silica and/or alumina with titania and an amorphous metal oxide as a second layer, on a substrate.

In addition, International Publication No. 01/068786 (Document 3) discloses a member comprising a substrate, and surface layer jointed to a surface of the substrate and containing photocatalytic titanium oxide and amorphous tungsten oxide, the photocatalytic titanium oxide and the amorphous tungsten oxide being jointed to each other without the formation of a solid solution thereof. Japanese Unexamined Patent Application Publication No. 2004-2104 (Document 4) discloses a hydrophilic, antifogging, and antifouling thin film comprising a metal oxide such as silica and ultrafine particles having photocatalytic activity which are formed from titanium oxide and/or tungsten oxide, the thin film having a specific surface morphology. Japanese Unexamined Patent Application Publication No. 2006-63426 (Document 5) discloses a superhydrophilic thin film formed on a substrate by plasma spraying of oxide particles formed from titanium dioxide and at least one of silicon dioxide and tungsten trioxide, and further discloses a superhydrophilic thin film obtained by subjecting the above-mentioned thin film to an oxidation treatment using flame of a gas burner.

Generally, the hydrophilicity of these thin films utilizes photocatalysis of titanium oxide or tungsten oxide. The mechanism of a phenomenon in which a photocatalyst provides photoinduced superhydrophilicity is thought to be as follows. Specifically, electrons and holes are generated by photoexcitation, then the generated holes react with oxygen atoms in a lattice to generate oxygen defects on a surface, and subsequently water in the atmosphere adsorbs to the generated oxygen defect sites to be stabilized. In addition, also disclosed is that the superhydrophilic thin film described in Document 5 shows superhydrophilicity without ultraviolet light irradiation, but the superhydrophilicity is not permanent because the mechanism thereof involves the utilization of the oxygen defects, and therefore ultraviolet light irradiation is required when the superhydrophilicity thereof is lowered.

Superhydrophilic films utilizing photocatalysis maintain superhydrophilicity during ultraviolet light irradiation. However, when the ultraviolet light irradiation is terminated, the hydrophilicity is lowered with time, although the hydrophilicity is maintained immediately after the termination.

Meanwhile, Japanese Unexamined Patent Application Publication No. 2006-205531 (Document 6) discloses a superhydrophilic thin film obtained by calcining a non-volatile silicone which does not show photocatalytic activity with a fine-particulate metal oxide of silicon dioxide or the like. In addition, Document 6 also discloses that it is considered that the superhydrophilicity of this thin film utilizes interaction between a fine structure of the surface of a coating film and capillary force.

U.S. Pat. No. 5,858,457 (Document 7), U.S. Pat. No. 5,922,299 (Document 8), International Application Japanese-Phase Publication No. 2003-520745 (Document 9), and International Application Japanese-Phase Publication No. 2005-538921 (Document 10) disclose methods for producing a mesoporous thin film using a surfactant. U.S. Pat. No. 6,592,764 (Document 11) discloses a method for forming a material having a mesoscopic structure by use of an amphiphilic block polymer.

### DISCLOSURE OF THE INVENTION

The present invention has been made in view of the above-described problems of the conventional techniques. An object of the present invention is to provide a transparent mesoporous silica thin film having high hydrophilicity and being capable of maintaining the hydrophilicity for a long period without using titanium oxide, a highly hydrophilic material comprising the same, and a method for producing the mesoporous silica thin film.

The present inventors have earnestly studied in order to achieve the above object. As a result, the inventors have found the following fact. Specifically, a mesoporous silica thin film is prepared from a solution containing a silica precursor and a water-soluble tungsten compound, so that tungsten is introduced into a framework of the mesoporous silica. Thereby, it is possible to obtain a mesoporous silica thin film having high hydrophilicity and being capable of maintaining the hydrophilicity for a long period, without using titanium oxide and/or without ultraviolet light irradiation. This finding has led to the completion of the present invention.

Specifically, a tungsten-containing mesoporous silica thin film of the present invention is a mesoporous silica thin film formed from a solution containing a silica precursor and a water-soluble tungsten compound, and has a molar ratio (W/Si) of tungsten content to silicon content of 0.001 to 0.04, a film thickness of 0.1 to 5 μm, and an average pore diameter of 20 nm or less.

Preferably, a contact angle of water on a surface of the tungsten-containing mesoporous silica thin film before ultraviolet light irradiation is less than 10°. The tungsten-containing mesoporous silica thin film preferably has any of an ordered porous structure and a hexagonal mesoporous structure.

For the tungsten-containing mesoporous silica thin film of the present invention, the silica precursor is preferably at least one silicon compound selected from the group consisting of tetraethyl orthosilicate, tetramethyl orthosilicate, methyltriethoxysilane, phenyltriethoxysilane, dimethyldimethoxysilane, and ethyltriethoxysilane.

Meanwhile, the water-soluble tungsten compound is preferably at least one tungsten compound selected from the group consisting of ammonium tungstate, tungstic acid, tungsten acetate, tungsten sulfate, tungsten chloride, and tungsten hydroxide.

A highly hydrophilic material of the present invention comprises a substrate, and the above-described tungsten-containing mesoporous silica thin film formed on the substrate. The substrate is preferably any one of a metal, a coated metal, a glass, a ceramic, a tile, and a plastic.

A method for producing a tungsten-containing mesoporous silica thin film of the present invention comprises steps of preparing a silica precursor solution by mixing a silica precursor, a water-soluble tungsten compound, a structure directing agent, a catalyst, and a solvent; forming a coating film by applying the silica precursor solution on a substrate; removing a volatile component from the coating film; and obtaining a tungsten-containing mesoporous silica thin film of the present invention by removing the structure directing agent from the coating film.

The structure directing agent is preferably a polyoxyethylene ether-based surfactant. The solvent is preferably any one of an alcohol, water, and a mixed solvent thereof. The catalyst is preferably an inorganic acid and/or an organic acid.

In the method for producing a tungsten-containing mesoporous silica thin film of the present invention, the structure directing agent is preferably removed from the coating film by calcination at a temperature in a range from 150 to 500° C.

According to the present invention, it is possible to obtain a transparent mesoporous silica thin film having high hydrophilicity and being capable of maintaining hydrophilicity for a long period without using titanium oxide, and a highly hydrophilic material comprising the same.

### BRIEF DESCRIPTION OF THE DRAWINGS

FIG. 1 is a graph showing XRD patterns of mesoporous silica thin films obtained in Example 1 and Comparative Examples 1 to 3.

FIG. 2 is a graph showing XRD patterns of tungsten-containing mesoporous silica thin films obtained in Examples 1 to 3.

FIG. 3 is a graph showing ultraviolet-visible absorption spectra of the tungsten-containing mesoporous silica thin films obtained in Examples 1 to 3.

FIG. 4 is a graph showing a relationship between a storage time in dark place and a contact angle of water on a surface of a film, for a tungsten-containing mesoporous silica thin film obtained in Example 4.

### DETAILED DESCRIPTION OF THE PREFERRED EMBODIMENTS

The present invention will be described in detail below on the basis of preferred embodiments.

Firstly, a tungsten-containing mesoporous silica thin film and a highly hydrophilic material of the present invention will be described. The tungsten-containing mesoporous silica thin film of the present invention is formed from a solution containing a silica precursor and a water-soluble tungsten compound, and has a structure in which tungsten is introduced into a framework of a mesoporous silica, for example, a structure in which silicon in a framework of a mesoporous silica is replaced with tungsten.

Such a mesoporous silica thin film containing tungsten shows high hydrophilicity. Specifically, a contact angle of water on a surface of the film before ultraviolet light irradiation is preferably less than 10°, and more preferably 4° or less. If the contact angle of water is equal to or more than the upper limit, properties such as antifouling property, antifogging property, quick-drying property, antistatic property, and dew condensation prevention property tend to deteriorate.

In the tungsten-containing mesoporous silica thin film of the present invention, a molar ratio of tungsten content to silicon content (W/Si, hereinafter referred to as “content ratio of tungsten”) is 0.001 to 0.04. If the content ratio of tungsten is lower than the lower limit, high hydrophilicity is not provided to the mesoporous silica thin film or it is difficult to maintain the hydrophilicity for a long period. Meanwhile, if the content ratio of tungsten exceeds the upper limit, formation of the thin film becomes difficult. From such a viewpoint, the content ratio of tungsten is more preferably 0.005 to 0.01.

A film thickness of the tungsten-containing mesoporous silica thin film of the present invention is 0.1 to 5 μm. If the film thickness is lower than the lower limit, sufficiently high hydrophilicity is not expressed. Meanwhile, if the film thickness exceeds the upper limit, a transparent thin film is not obtained. From such a viewpoint, the film thickness is more preferably 0.5 to 3 μm, and particularly preferably 0.5 to 1 μm.

In addition, an average pore diameter of the tungsten-containing mesoporous silica thin film of the present invention is 20 nm or less. If the average pore diameter exceeds the upper limit, sufficient high hydrophilicity is not expressed. From such a viewpoint, the average pore diameter is more preferably 10 nm or less, and particularly preferably 5 nm or less. The lower limit of the average pore diameter is not particularly limited, but is preferably 2 nm. This pore diameter can be controlled by appropriately selecting a type of a structure directing agent to be described later and a combination of the structure directing agent with the silica precursor.

A porous structure of the tungsten-containing mesoporous silica thin film of the present invention is preferably an ordered structure. With this structure, the thin film tends to show good mechanical strength. A degree of porosity and regularity of the porous structure can be controlled by appropriately selecting a type of a structure directing agent to be described later and a combination of the structure directing agent with the silica precursor. In addition, the regularity of the porous structure can be determined on the basis of existence of a single XRD Bragg peak in a measurement of X-ray diffraction.

In addition, the porous structure is more preferably a hexagonal mesoporous structure. With this structure, the thin film tends to show excellent mechanical strength. The hexagonal mesoporous structure can be determined on the basis of existence of an XRD Bragg peak in a range of 2θ=2° to 6° in a measurement of X-ray diffraction.

The tungsten-containing mesoporous silica thin film of the present invention is a colorless, transparent, and highly hydrophilic film, and is useful as a coating layer for various types of substrates. In addition, the film can be used as a layer forming a functional laminate such as an anti-reflection laminate.

The highly hydrophilic material of the present invention comprises a substrate and the tungsten-containing mesoporous silica thin film of the present invention formed on the substrate. Examples of the substrate include metals, coated metals, glasses, ceramics, tiles, plastics, and the like. More specific examples of the substrate include mirrors, lenses, spectacles lenses, optical elements, gauge covers, signposts, windows, retroreflectors, metals, perspexes, face shields, exterior materials and interior materials for construction, various medical equipments and medical devices, and the like. The tungsten-containing mesoporous silica thin film of the present invention is substantially transparent and has no interference color. Therefore, design of the substrate is not impaired even when the thin film is coated onto a surface of the substrate.

Next, methods for producing a tungsten-containing mesoporous silica thin film and a highly hydrophilic material of the present invention will be described.

A film is formed from a solution containing a silica precursor and a water-soluble tungsten compound by use of a structure directing agent such as a surfactant as a template, whereby the mesoporous structure of the tungsten-containing mesoporous silica thin film of the present invention can be formed. Specific examples include the following method.

Firstly, a silica precursor, a water-soluble tungsten compound, a structure directing agent, a catalyst, and a solvent are homogeneously mixed to prepare the silica precursor solution. The tungsten-containing mesoporous silica thin film in which tungsten element is dispersed at a high level can be formed by applying the homogeneously mixed silica precursor solution onto a substrate.

A ratio of the silica precursor and the water-soluble tungsten compound in the silica precursor solution is preferably equivalent to a ratio at which a molar ratio (W/Si) of tungsten content to silicon content of 0.001 to 0.04, and more preferably a molar ratio (W/Si) of 0.005 to 0.02. When the ratio of the silica precursor and the water-soluble tungsten compound is within the above range, a tungsten-containing mesoporous silica thin film having the above-described content ratio of tungsten can be formed.

A ratio of the structure directing agent is preferably 0.001 to 1.0 mol, more preferably 0.01 to 0.5 mol, and particularly preferably 0.05 to 0.3 mol, relative to 1 mol of a total amount of the silica precursor and the water-soluble tungsten compound. A mesoporous silica thin film having a desired degree of porosity can be obtained by varying the ratio of the structure directing agent to control a porosity of the tungsten-containing mesoporous silica thin film.

A ratio of the catalyst is preferably 0.05 to 0.4 mol and more preferably 0.07 to 0.2 mol, relative to 1 mol of a total amount of the silica precursor and the water-soluble tungsten compound. A ratio of the solvent is preferably 5 to 200 mol, more preferably 10 to 100 mol, and particularly preferably 20 to 50 mol, relative to 1 mol of a total amount of the silica precursor and the water-soluble tungsten compound.

Examples of the silica precursor used in the present invention include tetraethyl orthosilicate, tetramethyl orthosilicate, methyltriethoxysilane, phenyltriethoxysilane, dimethyldimethoxysilane, ethyltriethoxysilane, and the like. These silica precursors may be used alone or in combination of two or more. Among these silica precursors, tetraethyl orthosilicate is particularly preferable from the viewpoint of stability of the precursor solution and economical efficiency (inexpensive price).

Examples of the water-soluble tungsten compound used in the present invention include ammonium tungstate, tungstic acid, tungsten acetate, tungsten sulfate, tungsten chloride, tungsten hydroxide, a chelated tungsten, pentaethoxytungsten, pentamethoxytungsten, pentapropoxytungsten, pentabutoxytungsten, and the like. These water-soluble tungsten compounds may be used alone or in combination of two or more. Among these water-soluble tungsten compounds, ammonium tungstate, tungstic acid, tungsten acetate, tungsten sulfate, tungsten chloride, and tungsten hydroxide are preferable from the viewpoint of high solubility in water and economical efficiency (inexpensive price).

Examples of the structure directing agent used in the present invention include surfactants, such as polyoxyethylene ether-based surfactants. More specific examples thereof include C₁₂H₂₅(OCH₂CH₂)₁₀OH, C₁₆H₃₃(OCH₂CH₂)₁₀OH, C₁₈H₃₇ (OCH₂CH₂)₁₀OH, C₁₂H₂₅ (OCH₂CH₂)₄OH, C₁₆H₃₃ (OCH₂CH₂)₂OH, and poly(alkylene oxide) triblock copolymers such as poly(ethylene oxide)-poly(propylene oxide)-poly(ethylene oxide) (PEO-PPO-PEO) and an inversion type thereof, namely, (PPO-PEO-PPO). These surfactants may be used alone or in combination of two or more. The degree of porosity, pore diameter and pore shape of the tungsten-containing mesoporous silica thin film of the present invention can be controlled by appropriately selecting a type of the structure directing agent and a combination of the structure directing agent with the silica precursor. Among these structure directing agents, C₁₂H₂₅ (OCH₂CH₂)₁₀OH, C₁₆H₃₃ (OCH₂CH₂)₁₀OH, C₁₈H₃₇ (OCH₂CH₂)₁₀OH, C₁₂H₂₅ (OCH₂CH₂)₄OH, and C₁₈H₃₃ (OCH₂CH₂)₂OH are preferable from the viewpoint of film formability (for example, a film is formed in good appearance, and cracks are less likely to generate).

Examples of the catalyst used in the present invention include acetic acid and inorganic acids such as nitric acid and hydrochloric acid. Another organic acid can also be used. These catalysts may be used alone or in combination of two or more. Among these catalysts, hydrochloric acid is particularly preferable from the viewpoint of volatility and economical efficiency (inexpensive price).

Examples of the solvent used in the present invention include water-soluble solvents such as alcohols (for example, ethanol, methanol and isopropanol); solvents having high dielectric constant such as ketones (for example, acetone), amides (for example, N-methyl formamide and formamide), and polyols (for example, glycerol and ethylene glycol); and water (purified water and ion-exchanged water). These solvents may be used alone or in combination of two or more. These solvents are preferably used in combination of two or more solvents from the viewpoint that a size and an amount of the surfactant can widely be varied, and a mixed solvent of an alcohol and water is particularly preferable. A molar ratio of water and an alcohol (water/alcohol) mixed in the mixed solvent is preferably 0.25 to 4. A size of micelles can be varied by changing the molar ratio of water and an alcohol which are mixed. Among the solvents, ethanol, water and a mixed solvent thereof are particularly preferable.

Next, this silica precursor solution is applied on the substrate to form a coating film. The application method is not particularly limited, and a known method such as dip coating, spin coating, spray coating, or gravure coating can be employed. Among these methods, spin coating is preferable from the viewpoint that atmosphere control is not required and a thin film having a uniform thickness can easily be formed over a wide range from a small region to a large region, when the solution containing the surfactant is applied.

Subsequently, volatile components such as the catalyst and the solvent are removed from the coating film. Examples of methods for removing the volatile components include known methods such as a method of drying the coating film. When the volatile components are removed by drying, the drying temperature and drying time are not particularly limited, as long as the temperature and the time allow the volatile components to be sufficiently removed from the coating film. For example, the drying temperature may be a temperature from room temperature to 100° C. In addition, when the drying is conducted by heating, the heating may be conducted at a constant temperature or may be conducted with stepwise temperature rise.

After that, the structure directing agent is removed from the coating film. Thereby, a hydroxylated tungsten-containing mesoporous silica thin film having a mesoporous structure in which tungsten is introduced into a framework of the mesoporous silica is formed. Examples of methods for removing the structure directing agent include known methods such as a method of calcining the coating film after drying. When the structure directing agent is removed by calcination, the calcination temperature is not particularly limited as long as the temperature allows the structure directing agent to be sufficiently removed from the coating film. However, the temperature is preferably 150° C. to 500° C. In addition, the calcination time is not particularly limited as long as the time allows the structure directing agent to be sufficiently removed from the coating film. However, the time is preferably 0.5 to 5 hours. The calcination may be conducted at a constant temperature, or may be conducted with stepwise temperature rise.

Here, drying temperature, drying time, calcination temperature, and calcination time are appropriately set in accordance with types and amounts of the structure directing agent, the catalyst, and the solvent used.

### EXAMPLES

The present invention will be more specifically described on the basis of Examples and Comparative Examples. However, the present invention is not limited to these Examples below.

### Example 1

In a container made of Teflon (registered trademark), C₁₂H₂₅ (OCH₂CH₂)₄OH (trade name: “Brij 30”, 0.15 mol) as a structure directing agent, ethanol (6 mol) and ion-exchanged water (20 mol) as a solvent, and hydrochloric acid (0.1 mol) as a catalyst were mixed. To this mixture, 0.01 mol of ammonium tungstate and 1.0 mol of tetraethoxysilane were added, and the resultant mixture was stirred at 20° C. for 20 minutes. The obtained silica precursor solution was uniformly applied onto a quartz substrate by a spin coating method (4000 rpm). After this coating film was dried at room temperature for 1 day, the quartz substrate was heated in the air to 250° C. at a rate of rising temperature of 1° C./minute. Further, the coating film was calcined by heating in the air at 250° C. for 5 hours. Thereby, a tungsten-containing mesoporous silica thin film (hereinafter referred to as “W-HMS (0.01)”) having a film thickness of approximately 0.5 to 0.8 μm, an average pore diameter of approximately 2 nm, and a content ratio of tungsten of 0.01 was obtained.

### Example 2

A tungsten-containing mesoporous silica thin film (hereinafter referred to as “W-HMS (0.005)”) having a film thickness of approximately 0.5 to 0.8 μm, an average pore diameter of approximately 2 nm, and a content ratio of tungsten of 0.005 was obtained in the same manner as in Example 1, except that an amount of the ammonium tungstate added was changed to 0.005 mol.

### Example 3

A tungsten-containing mesoporous silica thin film (hereinafter referred to as “W-HMS (0.02)”) having a film thickness of approximately 0.5 to 0.8 μm, an average pore diameter of approximately 2 nm and a content ratio of tungsten of 0.02 was obtained in the same manner as in Example 1, except that an amount of the ammonium tungstate added was changed to 0.02 mol.

### Comparative Example 1

A titanium-containing mesoporous silica thin film (hereinafter referred to as “Ti—HMS (0.01)”) having a film thickness of approximately 0.5 to 0.8 μm, an average pore diameter of approximately 2 nm, and a molar ratio of titanium content to silicon content of 0.01 was obtained in the same manner as in Example 1, except that 0.01 mol of tetraethyl orthotitanate was used instead of the ammonium tungstate.

### Comparative Example 2

A molybdenum-containing mesoporous silica thin film (hereinafter referred to as “Mo—HMS (0.01)”) having a film thickness of approximately 0.5 to 0.8 μm, an average pore diameter of approximately 2 nm, and a molar ratio of molybdenum content to silicon content of 0.01 was obtained in the same manner as in Example 1, except that 0.0014 mol (equivalent to 0.01 mol of molybdenum) of ammonium heptamolybdate tetrahydrate was used instead of the ammonium tungstate.

### Comparative Example 3

A vanadium-containing mesoporous silica thin film (hereinafter referred to as “V-HMS (0.01)”) having a film thickness of approximately 0.5 to 0.8 μm, an average pore diameter of approximately 2 nm, and a molar ratio of vanadium content to silicon content of 0.01 was obtained in the same manner as in Example 1, except that 0.01 mol of ammonium vanadate was used instead of the ammonium tungstate.

### <X-Ray Diffraction>

XRD patterns of the mesoporous silica thin films obtained in Examples 1 to 3 and Comparative Examples 1 to 3 were measured by use of a desktop X-ray diffractometer (manufactured by Rigaku Corporation, trade name: “MiniFlex”) using CuKα (wavelength: 1.5418 Å) as a light source.

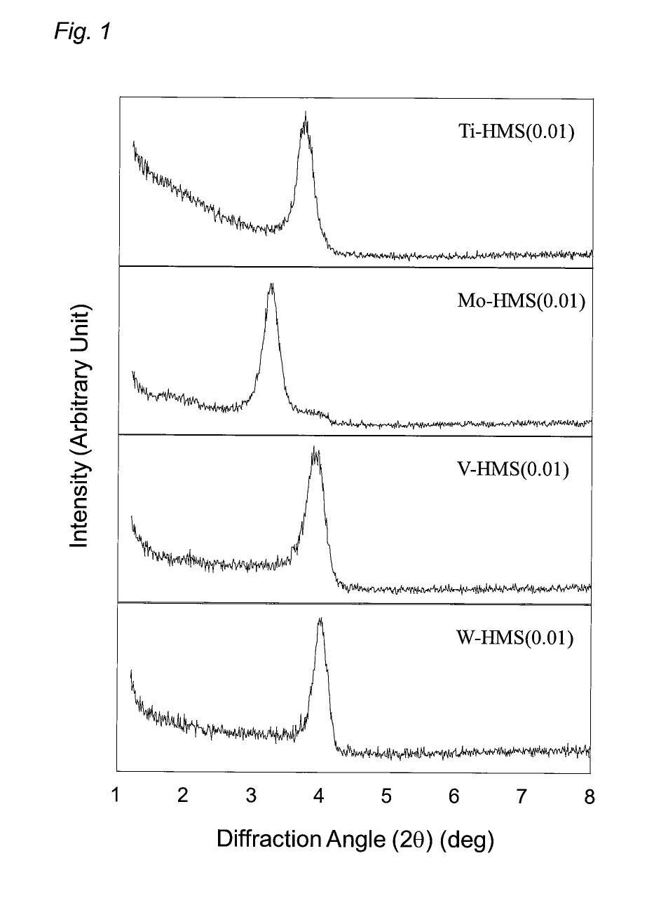

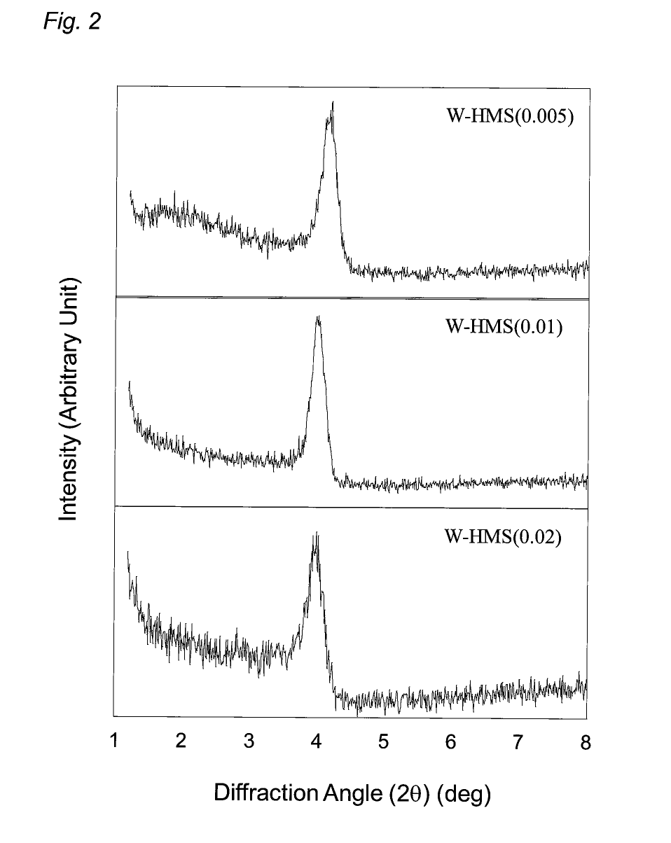

FIG. 1 shows the XRD patterns of the W-HMS (0.01), the Ti—HMS (0.01), the Mo—HMS (0.01), and the V-HMS (0.01). FIG. 2 shows the XRD patterns of the W-HMS (0.005), the W-HMS (0.01), and the W-HMS (0.02).

As apparent from the results shown in FIG. 1, a single XRD Bragg peak due to d₁₀₀ plane was observed at 2θ=3° to 4°. From these results, it was found that an ordered hexagonal mesoporous structure was formed in mesoporous silica thin films containing any of the metals.

In addition, as apparent from the results shown in FIG. 2, a single XRD Bragg peak due to d₁₀₀ plane was observed at or around 20=4°. From these results, it was found that a W-HMS having an ordered hexagonal mesoporous structure was formed at all the content ratios of tungsten.

### <Ultraviolet-Visible Absorption Spectrum>

Ultraviolet-visible absorption spectra of the tungsten-containing mesoporous silica thin films obtained in Examples 1 to 3 were measured by use of a spectrophotometer (manufactured by Shimadzu Corporation, trade name: “UV-2550”).

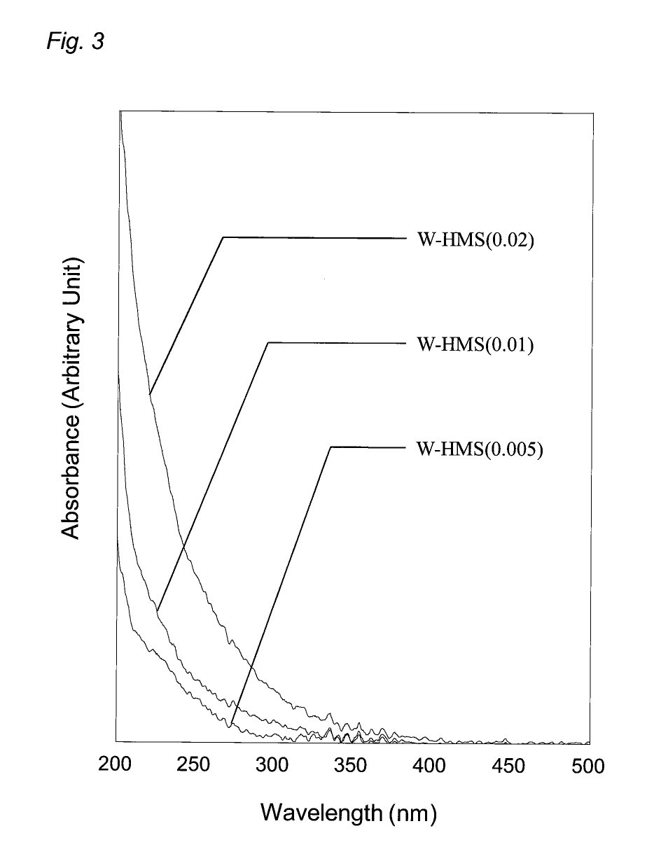

FIG. 3 shows the ultraviolet-visible absorption spectra of the W-HMS (0.005), the W-HMS (0.01), and the W-HMS (0.02). AS apparent from the results, it was found that each of the W-HMSs was colorless and transparent, because of no absorption in the visible light region. In addition, it was found that the tungsten content in the mesoporous silica thin films was increased with the increase in an amount of ammonium tungstate added, because the absorption in ultraviolet region was due to tungsten.

### <Contact Angle of Water>

The mesoporous silica thin films obtained in Examples 1 to 3 and Comparative Examples 1 to 3 were stored in a dark place until contact angles of water on film surfaces became stable. Then, 0.01 ml of purified water was dropped on a surface of each of the mesoporous silica thin films, and a contact angle of water was measured by use of a contact angle measuring device (manufactured by Kyowa Interface Science Co., Ltd., trade name: “DropMaster 300”). Table 1 shows the results.

In addition, a surface of each of the mesoporous silica thin films obtained in Examples 1 to 3 and Comparative Examples 1 to 3 was subjected to ultraviolet light irradiation using a 100-W high-pressure mercury lamp. Then, 0.01 ml of purified water was dropped on the film surface, and a contact angle of water was measured by use of a contact angle measuring device (manufactured by Kyowa Interface Science Co., Ltd., trade name: “DropMaster 300”). Table 1 shows the results.

TABLE 1

| | | Contact angle of water (deg) | |
|---|---|---|---|
| | | Before UV | After UV |
| | | irradiation | irradiation |
| Ex. 1 | W-HMS (0.01) | 2.5 | 1 |
| Ex. 2 | W-HMS (0.005) | 1.5 | less than 1 |
| Ex. 3 | W-HMS (0.02) | 3.1 | less than 1 |
| Comp. Ex. 1 | Ti-HMS (0.01) | 5.8 | less than 1 |
| Comp. Ex. 2 | Mo-HMS (0.01) | 8.6 | 1 |
| Comp. Ex. 2 | V-HMS (0.01) | 4.5 | 1.7 |

As apparent from the results shown in Table 1, all of the tungsten-containing mesoporous silica thin films of the present invention (Examples 1 to 3), the titanium-containing mesoporous silica thin film (Comparative Example 1), the molybdenum-containing mesoporous silica thin film (Comparative Example 2), and the vanadium-containing mesoporous silica thin film (Comparative Example 3) had low contact angles of water before ultraviolet light irradiation, compared with a mesoporous silica thin film containing no transition metal (generally, having a contact angle of water before ultraviolet light irradiation of approximately 30°) and showed hydrophilicity. Among them, the tungsten-containing mesoporous silica thin films of the present invention (Examples 1 to 3) had contact angles of water before ultraviolet light irradiation of 4° or less, and showed very high hydrophilicity.

### Example 4

Tungsten-containing mesoporous silica thin films W-HMS (0.005), W-HMS (0.01), and W-HMS (0.02) having content ratios of tungsten of 0.005, 0.01, and 0.02, respectively, were prepared on quartz substrates in the same manner as in Examples 1 to 3.

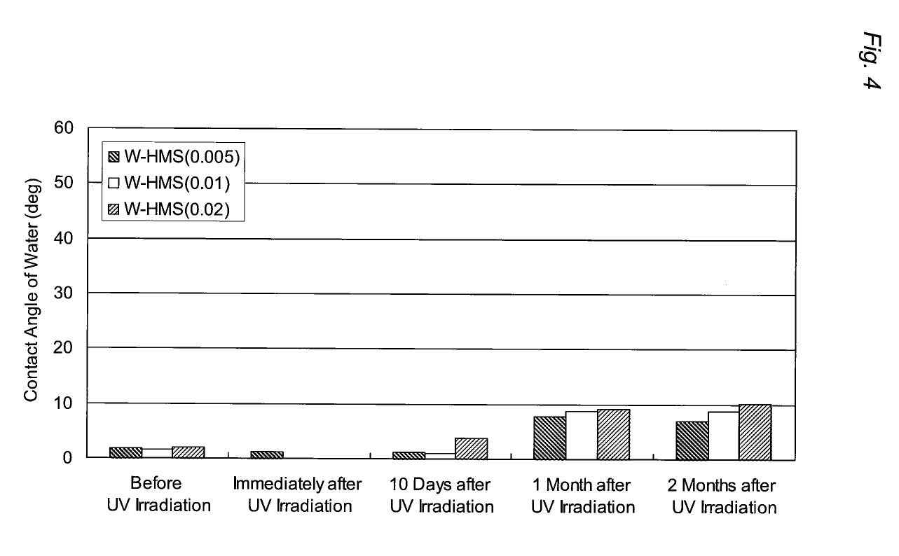

These mesoporous silica thin films were stored in a dark place until contact angles of water on film surfaces became stable. Then, contact angles of water on the film surfaces were measured in the same manner as in Examples 1 to 3. Next, the surface of each of the mesoporous silica thin films were subjected to ultraviolet light irradiation in the same manner as in Examples 1 to 3. Then, a contact angle of water on the film surface was measured. Thereafter, the mesoporous silica thin films were stored in a dark place, and a contact angle of water on the surface of each of the mesoporous silica thin films was measured 10 days, 1 month, and 2 months after the ultraviolet light irradiation in the same manner as in Examples 1 to 3. FIG. 4 shows these results.

As apparent from the results shown in FIG. 4, it was shown that the tungsten-containing mesoporous silica thin films of the present invention maintained high hydrophilicity for long periods without ultraviolet light irradiation.

### INDUSTRIAL APPLICABILITY

As described above, according to the present invention, it is possible to obtain a mesoporous silica thin film showing high hydrophilicity, being capable of retaining hydrophilicity for a long period, and being transparent. Such a mesoporous silica thin film has excellent properties such as antifouling property, antifogging property, quick-drying property, antistatic property, dew condensation prevention property. Therefore, a material comprising the mesoporous silica thin film is useful for various elements and mirrors having excellent antifogging property and quick-drying property, and materials for exterior walls having excellent antifouling property.

1. A tungsten-containing mesoporous silica thin film formed from a solution containing a silica precursor and a water-soluble tungsten compound, the tungsten-containing mesoporous silica thin film having
a molar ratio (W/Si) of tungsten content to silicon content of 0.001 to 0.04,
a film thickness of 0.1 to 5 μm,
an average pore diameter of 20 nm or less, and
a Bragg XRD peak due to d₁₀₀ plane at or around 20=4° in an X-ray diffraction pattern.

2. The tungsten-containing mesoporous silica thin film according to claim 1, wherein a contact angle of water on a surface of the film before ultraviolet light irradiation is less than 10°.

3. The tungsten-containing mesoporous silica thin film according to claim 1, wherein the tungsten-containing mesoporous silica thin film has an ordered porous structure.

4. The tungsten-containing mesoporous silica thin film according to claim 1, wherein the tungsten-containing mesoporous silica thin film has a hexagonal mesoporous structure.

5. The tungsten-containing mesoporous silica thin film according to claim 1, wherein the silica precursor is at least one silicon compound selected from the group consisting of tetraethyl orthosilicate, tetramethyl orthosilicate, methyltriethoxysilane, phenyltriethoxysilane, dimethyldimethoxysilane, and ethyltriethoxysilane.

6. The tungsten-containing mesoporous silica thin film according to claim 1, wherein the water-soluble tungsten compound is at least one tungsten compound selected from the group consisting of ammonium tungstate, tungstic acid, tungsten acetate, tungsten sulfate, tungsten chloride, and tungsten hydroxide.

7. A highly hydrophilic material comprising:
a substrate; and
the tungsten-containing mesoporous silica thin film according to claim 1 formed on the substrate.

8. The highly hydrophilic material according to claim 7, wherein the substrate is any one of a metal, a coated metal, a glass, a ceramic, a tile, and a plastic.

9. A method for producing a tungsten-containing mesoporous silica thin film, comprising steps of:
preparing a silica precursor solution by mixing a silica precursor, a water-soluble tungsten compound, a polyoxyethylene ether-based surfactant, a catalyst, and a solvent;
forming a coating film by applying the silica precursor solution on a substrate;
removing a volatile component from the coating film; and
obtaining the tungsten-containing mesoporous silica thin film according claim 1 by removing the polyoxyethylene ether-based surfactant from the coating film.

10. (canceled)

11. The method for producing the tungsten-containing mesoporous silica thin film according to claim 9, wherein the solvent is any one of an alcohol, water, and a mixed solvent thereof.

12. The method for producing the tungsten-containing mesoporous silica thin film according to claim 9, wherein the catalyst is an inorganic acid and/or an organic acid.

13. The method for producing the tungsten-containing mesoporous silica thin film according to claim 9, wherein the polyoxyethylene ether-based surfactant is removed from the coating film by calcination at a temperature in a range from 150 to 500° C.
